(19) United States
(12) Patent Application Publication
(10) Pub. No.: US 2005/0002035 A1
(43) Pub. Date: Jan. 6, 2005

(54) Exposure apparatus

(76) Inventor: Kazuhiko Mishima, Tochigi (JP)

Correspondence Address: MORGAN & FINNEGAN, L.L.P., 3 WORLD FINANCIAL CENTER, NEW YORK, NY, 10281-2101, US

(21) Appl. No.: 10/853,988

(22) Filed: May 25, 2004

(30) Foreign Application Priority Data
May 27, 2003 (JP) 2003-149196

(51) Int. Cl. G01B 11/00

(52) U.S. Cl. 356/401; 355/53

(57) ABSTRACT

An exposure apparatus for exposing a pattern on an original onto the substrate includes an illumination system for illuminating a mark on a substrate, a detector for detecting a position of the mark by detecting light from the mark via an optical system; a measurement unit for measuring a relationship between a focus state of the optical system on the mark and a position detection result of the mark, and a storage for storing substantially the same information as the relationship regarding the mark on the substrate to be exposed.

This application claims a benefit of foreign priority based on Japanese Patent Application No. 2003-149196, filed on May 27, 2003, which is hereby incorporated by reference herein in its entirety as if fully set forth herein.

### BACKGROUND OF THE INVENTION

The present invention relates generally to an exposure apparatus used to manufacture various semiconductor devices, such as ICs, LSIs, CCDs, liquid crystal panels, and magnetic heads, and more particularly to an exposure apparatus that include a position detecting means for precisely detecting a position of an object.

Recently, the semiconductor manufacturing technology has rapidly developed and the fine processing has remarkably advanced accordingly. In particular, reduction projection exposure apparatuses, such as so-called steppers and scanners, have submicron resolving power and are currently mainstream technology in the optical processing. Also, increasing of a numerical aperture (“NA”) in an optical system and shortening of a wavelength of exposure light are sought for more improved resolving power.

Along with the shortened exposure wavelength, an exposure light source has shifted from high-pressure mercury lamps, such as g-line and i-line lamps, to an excimer laser, such as KrF and ArF lasers.

A highly precise alignment between a wafer and a mask (or a reticle) in the projection exposure apparatus has been required with the improved resolving power of the projected pattern. The projection exposure apparatus is required to serve as not only a high-resolution exposure apparatus but also a precise position detector.

Accordingly, a position detector or a so-called alignment scope that detects a mark on a wafer, a mark on a stage, etc. should be precise in performance.

Two alignment systems have been generally proposed: One is a so-called off-axis automatic alignment system that includes an alignment scope that serves to detect an alignment mark without using a projection optical system. A position detecting system used for this system is referred to as an “OA detection system” hereinafter.

The other alignment system is called a Through the Lens (“TTL”) or Through the Lens Automatic Alignment (“TTL-AA”), which detects an alignment mark on a wafer through a projection optical system by incorporating the projection optical system into part of the position detecting system.

Currently, both systems use a method, which is precise and flexible for various semiconductor devices, for converting an image or image data of an alignment mark as an observed object into an electric signal using a photoelectric conversion element, and for calculating its position based on the electric signal.

A description will be given of a conventional projection exposure apparatus having a conventional OA detection system, with reference to a schematic view shown in FIG. 4.

Light IL exited from an illumination optical system 1 that includes an exposure light source, such as a mercury lamp, a KrF excimer laser, and an ArF excimer laser, illuminates a mask or a reticle 2, onto which a pattern is formed. The reticle 2 has been previously positioned on reticle holders 12 and 12′ by an alignment detection system 11 arranged above or underneath the reticle 2 so that an optical axis AX of a projection optical system 3 accords with a center of the reticle pattern.

The projection optical system 3 transfers an image of the light that passes through the reticle pattern, onto a wafer 6 held on a wafer stage 8 at a predetermined magnification. The exposure apparatus is called a stepper when irradiating the illumination light from the top of the reticle and sequentially exposes the reticle pattern onto the wafer 6 via the projection optical system at the fixed position. On the other hand, the exposure apparatus is called a scanner or scanning exposure apparatus when relatively driving the reticle and the wafer (where the reticle's drive amount is the projection magnification times the wafer's drive amount).

A certain type of wafer 6 has previously formed a pattern and is called a second wafer. A position of the wafer should be detected prior to forming a next pattern on this wafer by a position detecting method, such as the above off-axis alignment system and TTL system (although FIG. 4 just shows an off-axis alignment system).

The OA detection system 4 is configured independently of the projection optical system 3. A wafer stage 8 is driven based on a laser interferometer 9 that can measure a lateral distance (in a direction parallel to the wafer stage), and positions the wafer 6 in the observation area for the OA detection system 4. The OA detection system 4 detects the alignment mark formed on the wafer 6, which has been positioned by the laser interferometer 9, providing chip or device arrangement information formed on the wafer 6.

Next, based on the arrangement information of this chip or device, the wafer stage 8 moves the wafer 6 to an exposure area of a projection optical system 3, i.e., a reticle's transfer area, and is sequentially exposed.

A focus detecting system 5 (501 to 508) is usually provided in the exposure area of the projection optical system 3 and measures a position of the wafer 6 in the optical-axis direction of the projection optical system to arrange the wafer 6 at a focus position of the projection optical system 3. The focus detecting system 5 is configured so that light emitted from an illumination optical source 501 illuminates a slit pattern 503 via an illumination lens 502. The light that passes through the slit pattern 503 images the slit pattern on the wafer 6 through an illumination optical system 504 and a mirror 505.

The slit pattern projected on the wafer 6 is reflected on the wafer surface, and enters the mirror 506 and a detection optical system 507 that is opposite to the illumination system. The detection optical system 507 reforms the slit image formed on the wafer 6 on a photoelectric conversion element 508. When the wafer 6 moves up and down, the slit image on the photoelectric conversion element 508 moves and its movement causes the wafer 6 to move in the focus direction along the optical-axis direction of the projection optical system. Plural slits are usually prepared on the wafer 6, and detection of respective focus positions (or multipoint detection on the wafer 6) can measure not only the wafer 6's movement in the focus direction but also the wafer 6's inclination relative to the image surface of the reticle image of the projection optical system 3.

Alignment marks AM formed on an actual, processed wafer 6 in such a projection exposure apparatus have different characteristics, such as width, a step height, and process layering condition. In addition, the alignment detection system has variable illumination conditions or modes, such as a detection wavelength and a NA, for precise detections of these various alignment marks.

An AF system for exclusive use with an OA detection system (not shown), which is referred to as an OA-AF system, is provided to measure a wafer's height relative to the OA detection system or a position in the OA detection system in the optical-axis direction. The OA-AF system is used to calculate the best focus position relative to the alignment mark on the wafer 6 and detect contrast changes and Z-position of the alignment mark.

A detailed description of the TTL-AA system is omitted here, but it is different from the OA detection system only in that it observes through the projection optical system 3. Other than that, it can vary variable illumination conditions to detect various alignment marks.

The OA detection system 4 etc. have an alignment measurement error component, referred to as a “defocus characteristic” hereinafter. The defocus characteristic results from a fluctuating detection position of the alignment mark in a direction horizontal to the optical axis when a focus Z-position or a position in the optical-axis direction in the detection system changes.

FIG. 9 shows a schematic view of a principle of this defocus characteristic. FIG. 9A shows that the alignment mark AM moves by ±ΔZ from the best focus position in the focus Z-direction, and a detection or illumination optical axis ML of the OA detection system 4 inclines. FIG. 9B shows a position of the defocused alignment mark while the detection or illumination optical axis inclines. Since the detection optical axis inclines, the alignment mark AM causes a lateral offset ±ΔD in a measurement direction X.

When the alignment mark AM with a defocus characteristic is measured, scattering of the positions of the alignment mark AM in the Z-direction reflects scattering in the measurement direction X, deteriorating the precision of the detection. Accordingly, as in Japanese Patent Application, Publication No. 10-022211, prior art adjusts detection and illumination optical axes so as to maintain the defocus characteristics as small as possible.

Japanese Patent Application, Publication No. 10-022211 corrects a defocus characteristic for a base adjustment mark on the premise that the actual mark to be aligned has the same defocus characteristic as the adjustment mark.

It has been discovered, however, that the defocus characteristic cannot be uniformly minimized for all the wafers in the actual detection system, since the defocus characteristic remains more or less, and changes according to a type and structure of the observed alignment mark AM and the illumination mode.

As the residual defocus characteristic and alignment mark AM's position in the Z-direction scatter according to wafers, the alignment measurement precision and the thus overlay accuracy deteriorate disadvantageously.

### BRIEF SUMMARY OF THE INVENTION

Accordingly, it is an exemplary object of the present invention to provide an exposure apparatus that reduces the defocus characteristic.

An exposure apparatus according to the present invention for exposing a pattern on an original onto the substrate includes an illumination system for illuminating a mark on a substrate, a detector for detecting a position of the mark by detecting light from the mark via an optical system, a measurement unit for measuring a relationship between a focus state of said optical system on the mark and a position detection result of the mark, and a storage for storing substantially the same information as the relationship regarding the mark on the substrate to be exposed.

The present invention can detect a position of the target with precision.

Other modes of the present invention will be apparent from the following description of the embodiments.

### BRIEF DESCRIPTION OF THE DRAWINGS

FIG. 1 is a schematic view of a position detector of an instant embodiment.

FIG. 2 is a schematic view of a rotary aperture stop that can vary illumination s of the instant embodiment.

FIG. 3 is a schematic view of a structure of a parallel plate 406.

FIG. 4 is a schematic view of an entire exposure apparatus.

FIG. 5 are graphs showing defocus characteristics under different conditions.

FIG. 6 is a graph when the defocus characteristic has been made minimum.

FIG. 7 is a schematic view 1 of an alignment mark signal generated due to a different illumination mode.

FIG. 8 is a schematic view 2 of an alignment mark signal generated due to a different illumination mode.

FIG. 9 is a schematic view for explaining a generation mechanism of the defocus characteristic.

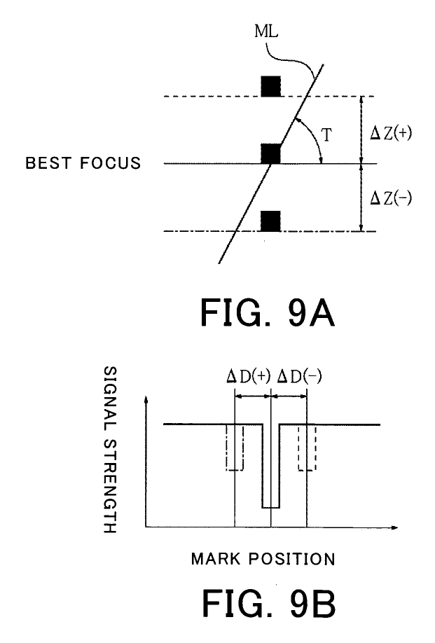

FIG. 10 is a graph showing contrast changes to positions in a Z direction at the image autofocus measurement time.

FIG. 11 is a wafer exposure sequence.

FIG. 12 is a sequence of an image autofocus measurement.

FIG. 13 is a flowchart for explaining an inventive semiconductor device manufacture method.

FIG. 14 is a flowchart of an inventive semiconductor device manufacture method.

### DETAILED DESCRIPTION OF THE PREFERRED EMBODIMENTS

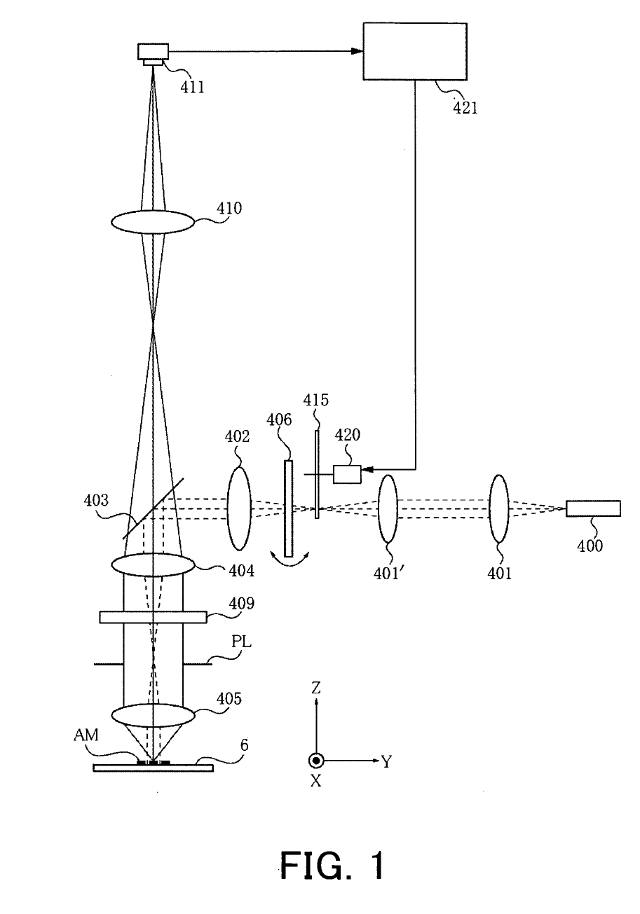

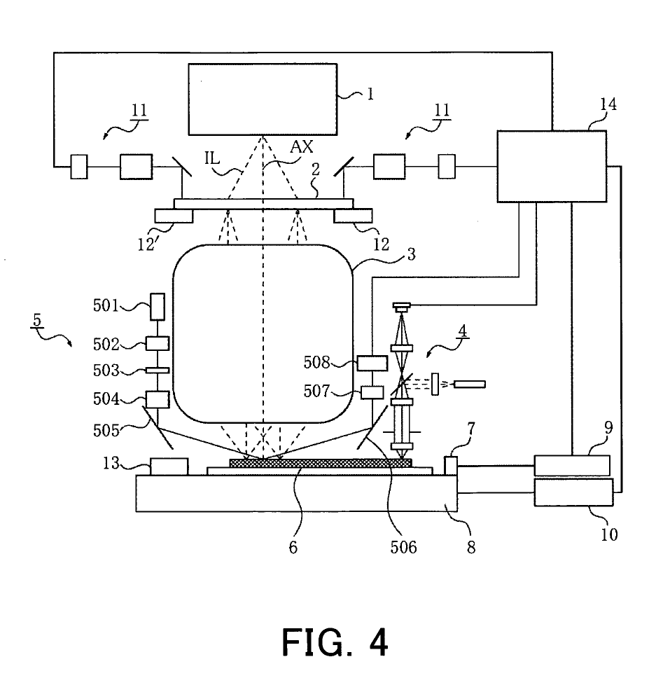

A description will now be given of an embodiment according to the present invention. The present invention applies the present invention to the off-axis alignment system. A description will be given of an off-axis (“OA”) detection of the instant embodiment, with reference to FIG. 1. This OA detection system corresponds to the OA detection system or alignment detecting system 4 in the projection optical system in FIG. 4.

In FIG. 1, the light introduced from an illumination light source 400 (such as a fiber) passes through illumination relay optical systems 401 and 401′. The illumination relay optical systems 401 and 401′ image a fiber end surface on a rotary aperture stop 415, which will be described later. The fiber end surface and the aperture stop 415 are conjugate with a pupil position PL (or an objective stop) of the objective lens 405, which will be described later. The light that passes through the rotary aperture stop 415 passes through the illumination pupil position correction optical system 406 and the optical system 402, and is introduced into the polarization beam splitter 403. A detailed description of the illumination pupil position correction optical system 406 will be discussed later. The s-polarized light perpendicular to the paper surface reflected by the polarization beam splitter 403, passes through he relay lens 404 and λ/4 plate 409, and is converted into the circular polarized light, and Koehler-illuminates the alignment mark AM formed on the wafer 6 through the objective lens 405.

The reflected light, diffracted light, and scattering light generated from the alignment mark AM return to the lens 405, the λ/4 plate 409, and the relay lens 404, then are converted into p-polarized light traveling parallel to the paper, and pass the polarization beam splitter 403. Thus, the imaging optical system 410 forms an image of the alignment mark AM on the photoelectric conversion element 411, such as a CCD camera. A position of the alignment mark AM and a position of the wafer 6 are detected based on the photoelectrically converted image of the alignment mark.

This is the basic configuration of the OA detection system of the instant embodiment, which includes an illumination optical system (401, 401′, 415, 406, 402, 403, 404, 409, PL, 405) for irradiating light from a light source onto the alignment mark AM, and a detection optical system (405, PL, 409, 404, 403, 410) for imaging an image of the alignment mark onto the photoelectric conversion element 411.

In order to precisely detect the alignment mark AM on the wafer 6, an image of the alignment mark AM should be clearly detected on the photoelectric conversion element 411. Therefore, the OA detection system 4 focuses on the alignment mark AM.

Therefore, an OA-AF detection system (not shown) is formed for measuring a focus position in the OA detection system. The alignment mark AM is detected by moving the alignment mark AM based on a detection result to the best focus surface in the OA detection system.

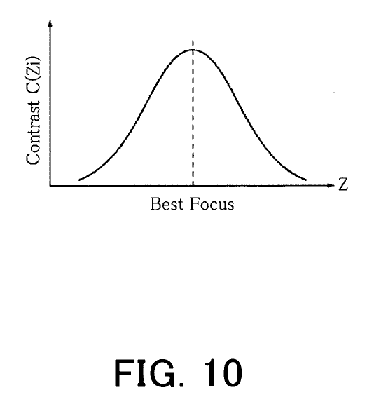

A description will now be given of a calculation of the best focus position for the OA detection system 4, with reference to FIG. 10. After the alignment mark AM is moved to the observation area of the OA detection system 4, the OA-AF system (not shown) measures a position of the alignment mark AM in the Z-direction. An image of the alignment mark AM is detected through predetermined Z-position driving based on the result of the OA-AF system, and the contrast of the alignment AM is calculated. The contrast of the alignment mark AM is calculated for respective Z-positions on the wafer, and the highest contrast position is determined as the best focus position. FIG. 10 shows the Z-positions in the abscissa axis (as measurement values of the OA-AF system) and contrast values of the alignment mark AM's images in the ordinate axis. The best focus position is thus obtained at the highest contrast Z-position. This measurement is referred to as an “image autofocus measurement”, hereinafter. The contrast is defined as a difference between the largest strength and the smallest strength in the alignment mark AM signal, calculated from a differential value of the signal strength, or defined in another way. In exposing plural wafers of the same process, the OA-AF system for image autofocus measurements is used to calculate the best focus position of the first wafer, for example, and only the measurement values of the OA-AF system are referred for the second and subsequent wafers, so as to eliminate a time-consuming measurement, like the image autofocus measurement. The alignment mark image can be always detected at high contrast while maintaining the throughput.

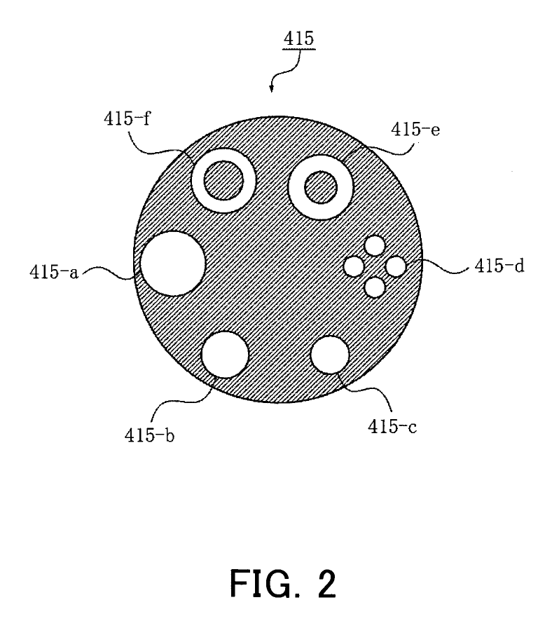

A detailed description will be given of a function of the rotary aperture stop 415, with reference to FIG. 2. FIG. 2 shows the rotary aperture stop 415 that forms plural spatial stops each allowing specific light through it. The rotary aperture stop 415 is connected to the rotational drive system 420, and rotates based on a command of the control system 421, so as to exchange one of various stop shapes (415a-f) and insert it into the optical path. In FIG. 2, the white part is a light-transmitting area, and beveled area is a light-shielding area. The rotary aperture stop 415 can be formed as a mechanical plate or made of glass onto which a chrome pattern is formed. Each of the stops 415a-f is as large as or smaller than the objective stop PL when converted at the position of the objective stop PL. The fiber end surface is dimensioned relative to each of the stops 415a-f so that the fiber end surface when converted on the rotary aperture stop is larger than each of the stop 415a-f.

The aperture stop 415 does not have to include plural different shapes, but may include, for example, a member that makes uniform the light intensity distribution within a surface, such as a diffuser, on its one surface.

The above configuration thus selects a stop (415a-f) from the rotary aperture stop 415, and provides the detection system with so-called variable illumination s or modified illumination. The illumination s is a ratio between the illumination light's NA and the detection light's NA. In this case, the illumination light's NA is a size (or a diameter) of the aperture of the rotary aperture stop 415, which has been converted on the PL in view of the imaging magnification. The detection light's NA is a PL's size. A separate description will be given of the effects of changing the illumination s.

The stop 415a is as large as the objective stop, and the illumination s at this time is referred to as s1. The stop 415b is smaller than the objective stop PL (as referred to as middle s), and the stop 415c is smaller than the stop 415b (as referred to as small s). The stop 415d forms quadrupole illumination, the stop 415e forms annular illumination 1, and the stop 415f forms annular illumination 2. Each stop shape is not limited to the above configuration, and may have various shapes suitable for the detection system.

It is not discussed whether the illumination optical system 400 (fiber) includes a mechanism for selecting a wavelength. However, when a wavelength switching filter (not shown) is provided, a wavelength suitable for the detection system can be selected.

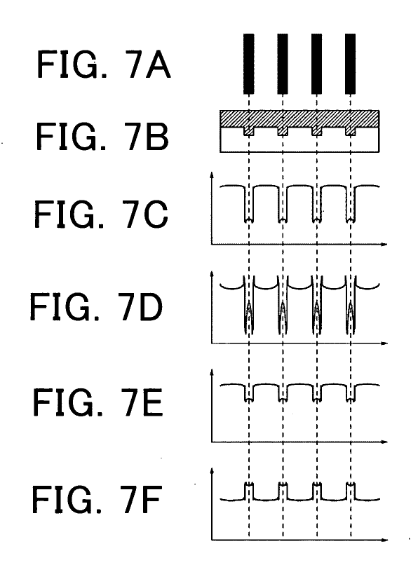

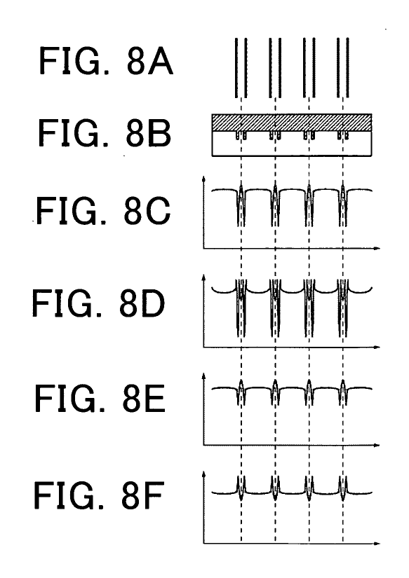

A description will be given of the effects of variable wavelength and illumination s, with reference to FIGS. 7 and 8. FIGS. 7A and 8A are schematic top views that observe two types of alignment marks, where a measurement direction is orthogonal to a mark longitudinal direction on the paper. FIGS. 7B and 8B show sectional structures of the alignment mark, and contemplates the same layering process (or the same semiconductor device manufacture process). The beveled part is assumed to be a transparent layer relative to an alignment wavelength. Each of FIGS. 7C to 7F and 8C to 8F show alignment signals obtained when the illumination s (i.e., each stop shape in the rotary aperture stop) and the wavelengths are changed. A combination between each stop shape in the rotary aperture stop and the used wavelength is referred to as an “illumination mode” hereinafter.

FIGS. 7C and 8C show alignment signals observed with s1 and a first center wavelength. FIGS. 7D and 8D show alignment signals observed with a small s as the illumination s and the same wavelength. FIGS. 7E, 7F, 8E and 8F show alignment signals observed with s1 and second and third center wavelengths. It is understood that changing of the illumination mode provides different detection signals even for the same alignment mark. Further, the obtained detection signal changes when the alignment mark changes its shape even in the same illumination mode.

The alignment detection system is not limited to the structure shown in FIG. 1, and the present invention is applicable, for example, to a detection system that has different illumination light introducing positions, or includes plural imaging optical systems 410 and photoelectric conversion elements 411.

While the instant embodiment discusses the OA detection system that has a different structure from the projection optical system, the present invention or the similar structure is not limited to this structure. The present invention is applicable to the TTL system for observing the alignment mark on the wafer through the projection optical system.

The OA detection system of the instant embodiment can select a suitable one of illumination modes or optical conditions, and adopt the best optical condition according to the structures of the alignment mark AM on the wafer.

On the other hand, the alignment detection system has a problem of the defocus characteristic, as discussed. When the illumination mode is switchable as discussed above, the defocus characteristic can be different according to the different illumination modes. An alignment measured with a defocus characteristic causes a measurement error of a mark position by a product between the defocus characteristic and the OA-AF system's measurement errors. For example, when the OA-AF system has precision of 0.5 μm and the defocus characteristic is 10 mrad, the error becomes 10 mrad×0.5 μm=5 nm, causing a serious problem when higher alignment accuracy is demanded.

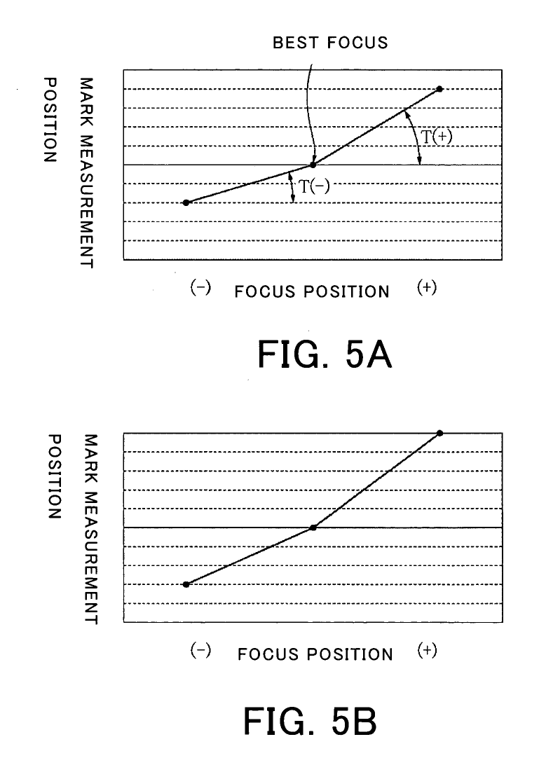

FIGS. 5A and 5B show exemplary graphs of defocus characteristics. In FIGS. 5A and 5B, the abscissa axis is a position of the alignment mark AM in the focus (or Z) direction relative to the OA detection system. The best focus position is a position measured by the above image autofocus measurement. The ordinate axis indicates the alignment mark AM's positions in the measurement direction for each focus position, and the measurement value varies when the defocus characteristic deteriorates. Different gradients T(+) and T(−) are seen on the focus's plus and minus sides, due to residual coma in the OA detection system or other reasons. Conventionally, the defocus characteristic has been adjusted relative to a specific alignment mark (or adjustment mark). The adjustment uses a pupil's position in the illumination system (i.e., a position on the element 415 perpendicular to the optical axis), etc. However, the instant inventor has discovered that the adjustment provided only for a specific alignment mark and a specific illumination mode does not always make the defocus characteristic zero if the alignment mark's structure and illumination mode change.

A difference in FIGS. 5A and 5B results from a difference between T(+) and T(−), and means that the defocus characteristic differs even in the same OA detection system.

Accordingly, the instant embodiment proposes a method comprising the steps of previously measuring the gradient components T(+) and T(−) according to the alignment mark's types and illumination modes, recording the defocus characteristics, conducting alignment while correcting the defocus characteristic using the correction means before a wafer is exposed, and exposing the wafer.

Turning back to FIG. 1, a description will now be given of an adjustment mechanism of the defocus characteristic. The defocus characteristic can be adjusted by changing a gradient (perpendicularity) of the illumination light incident upon the alignment mark AM. The inclination of the illumination light is an inclination of a gravity center of the light intensity distribution. In FIG. 1, the aperture stop 415 and the alignment mark AM are positioned in a Fourier transformation relationship.

The rotary aperture stop 415 is attached to the rotational drive system 420, which is a pulsed motor that can precisely determine a rotational position of the rotary aperture stop 415. The control system 421 selects a desired illumination s and inserts it in a direction perpendicular to the paper. Adjusting of feed per revolution of the pulsed motor can make a position variable in the direction perpendicular to the paper (or X-direction) on the wafer. In other words, adjusting of the feed per revolution of the pulsed motor for the rotary aperture stop 415 can decenter a position of the pupil in the illumination optical system, and adjust the inclination of the illumination light to the alignment mark AM and thus the defocus characteristic.

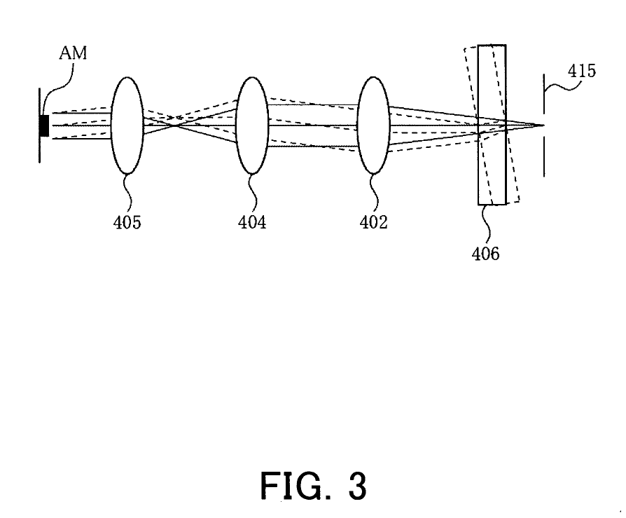

A description will be given of the adjustment of the Y mark on the wafer, with reference to FIGS. 1 and 3. In FIG. 1, 406 denotes an illumination optical system's pupil position correcting optical system (“PP correcting optical system” hereinafter) including a glass parallel plate, which is rotatable about a X-axis perpendicular to the paper by the drive system (not shown). The drive system (not shown) is connected to the control system 421, and driven by the command of the control system 421. A detailed description will be given of functions of this PP correcting optical system 406 with reference to FIG. 3.

FIG. 3 shows only the objective lens 405, relay lens 404, and illumination optical system 402 shown in FIG. 1 for simplicity purposes. The light that passes through the rotary aperture stop 415 passes through the neighboring PP correcting optical system 406. The PP correcting optical system 406 can be inclined as shown by a broken line in FIG. 3. When the PP correcting optical system 406 inclines, the optical axis offsets providing an effect that the rotary aperture stop 415 is moved in the Z-direction. Although the illumination light perpendicularly enters the alignment mark AM in the optical path of a solid line, inclining of the PP correcting optical system can incline the illumination light.

Thus, control over the illumination light's inclination, i.e., the inclination in the X direction and the inclination in the Y direction, is available in FIG. 1 by adjusting a rotational position of the rotary aperture stop 415 through the drive system 420 for the inclination in the X direction, and by adjusting an inclined angle of the PP correcting optical system 406 for the inclination in the Y direction. In other words, the above drive system can adjust the defocus characteristic.

While the above embodiment adjusts using a rotational position of the rotary aperture stop 415, etc., the present invention is not limited to this embodiment and applicable to an embodiment that uses a drive system for independently driving the X and. Y axes, as long as it has a mechanism for adjusting a gradient of the illumination light on the alignment mark AM.

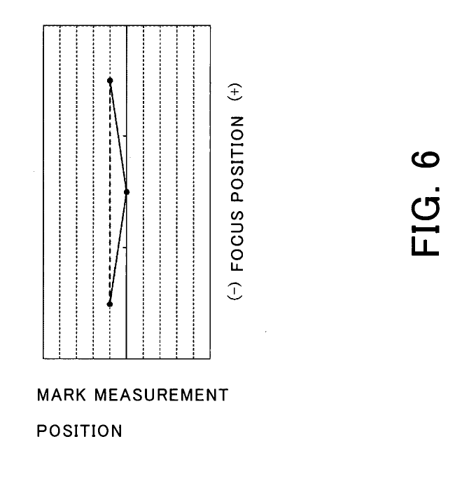

A description will be given of an adjustment procedure of the defocus characteristic in the structure that can adjust a gradient of the illumination light. As discussed, when the defocus characteristic is measured as shown in FIG. 5A or 5B, a mean value is calculated from T(+) and T(−) as T(Avg)={T(+)+T(−)}/2. Then, a position that provides a minimum T(Avg) is calculated from the defocus characteristic sensitivity of the rotary aperture stop 415 or the PP correcting optical system 406, which has already been obtained. As a result of the adjustment to the best focus position using the correcting system, the defocus characteristic can be inclined as shown in FIG. 6. This state can reduce the shift amount of the mark measurement position caused by the defocus characteristic, even though the detected mark defocuses in the plus or minus side. In other words, the above drive system can adjust the defocus characteristic that would occur due to differences in illumination condition, in structure of the alignment mark AM, etc.

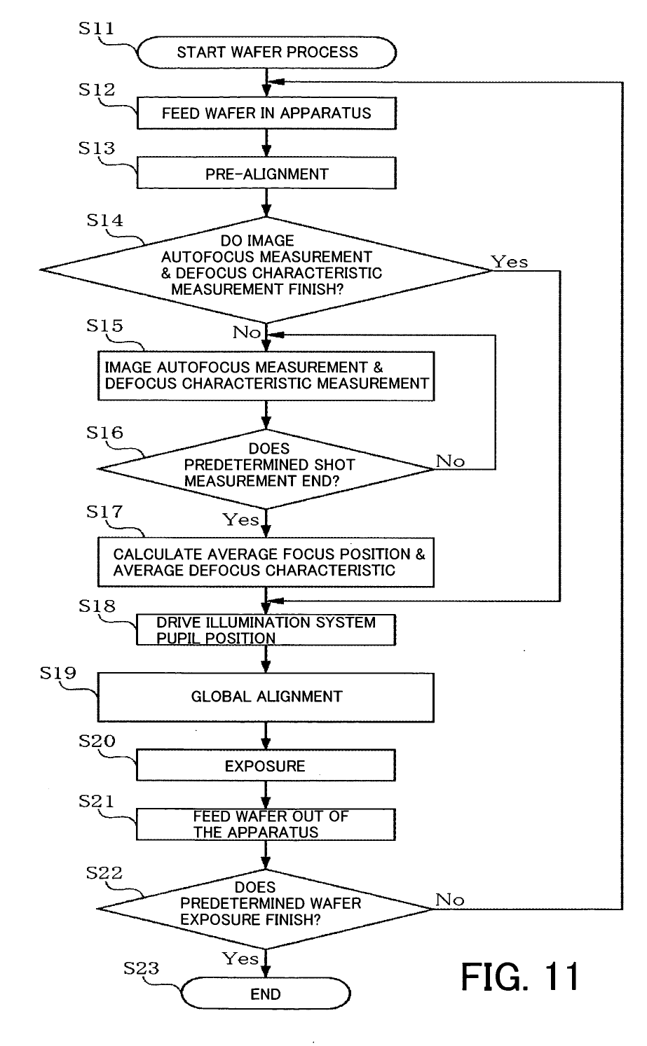

A description will be given of the exposure sequence in the exposure apparatus that serves to automatically correct the defocus characteristic using the above correcting system, with reference to FIG. 11.

A sequence starts which exposes plural specifically processed wafers (S11). One wafer is fed (S12), and subject to mechanical arrangement and pre-alignment (i.e., an alignment with relatively low precision) (S13). This pre-alignment moves the alignment mark AM to the measurement range for the subsequent global alignment (i.e., an alignment with relatively high precision). It is determined whether the image autofocus measurement and defocus characteristic measurement have finished for this mark (S14). Since this is the first wafer and the image autofocus measurement and defocus characteristic measurement have not yet been conducted, the process transfers to step S15. S15 drives the first alignment mark AM (or first shot) to the detection range of the OA detection system for the simultaneous measurements of image autofocusing and defocus characteristics, since the pre-alignment ends in S15, as detailed below.

When a normal global alignment is considered, the alignment mark should be measured for plural shots on the wafer. Therefore, it is determined whether the image autofocus measurement and defocus characteristic measurement have finished for predetermined sample shots (S16). For example, where measurements for four shots are set, after the first shot ends, the process returns to S15 and the image autofocus measurement and defocus characteristic measurement are conducted for the second shot. When the image autofocus measurement and defocus characteristic measurement end for the predetermined shots in S15 and S16, a mean value of the image autofocus measurements and a mean value of the defocus characteristics are calculated for plural shots (S17). The calculated defocus characteristic is stored in memory means (not shown). Subsequently, the best defocus characteristic adjustment condition is calculated based on the calculated mean value of the defocus characteristics for plural shots, and the pupil position in the illumination system is adjusted or the defocus characteristic is corrected (S18). The global alignment measurement (or a fine measurement) follows for alignment mark AM for predetermined fine measurements with the above corrected defocus characteristic at the optimal (average) image autofocus position, and the precise shot layout is calculated (Sl9). The exposure starts based on the shot layout information (S20). After the exposure to the first wafer ends, the wafer is fed out (S21), and it is determined whether the predetermined number of wafers have been exposed (S22). Since this is the first wafer, the process returns to S12, and the similar sequence starts for the second, newly introduced wafer. Since S14 has calculated the optimal values for the image autofocus measurement and defocus characteristic for the first wafer, S15 to S17 are omitted and the global alignment measurement is conducted under the measurement condition for the first wafer (S19). The reason why the image autofocus measurement and defocus characteristic measurement can be omitted for the second and subsequent wafers is that it is the same process and the mark structure and illumination mode are the same. Omitting these measurements can improve the throughput. Conversely, if the optimal condition is recalculated for each wafer and the final overlay accuracy deteriorates, it is difficult to determine whether the deterioration results from the exposure apparatus or the process. Thus, the exposure ends for all the second and subsequent wafers (S23).

While the above embodiment discusses that whenever the wafer sequence starts, only the first wafer is subject to the image autofocus measurement and the defocus characteristic measurement, the present invention is not limited to this embodiment. For example, an operator can intentionally continue to expose the wafer under a specific defocus characteristic state, or can set the image autofocus measurement and the defocus characteristic measurement whenever the predetermined number of wafers are exposed. The exposure apparatus has a switch to execute such a measurement.

The above embodiment uses, but is not limited to, a method of measuring the defocus characteristic for a sample shot on the first wafer, and calculating and correcting the average corrective amount.

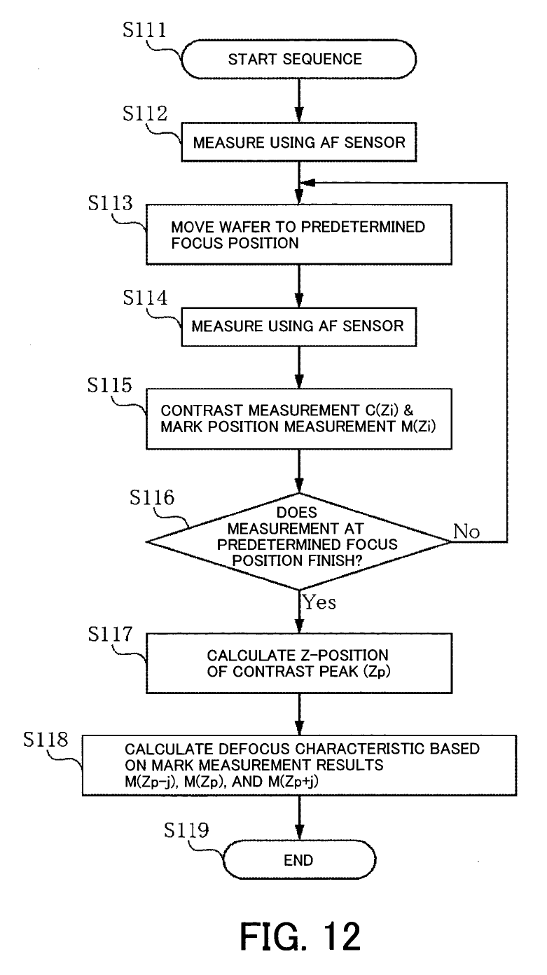

Following the description of the sequence of exposing a wafer, a detailed description will be given of the image autofocus measurement and the defocus measurement (S15), with reference to FIG. 12.

S111 starts S15 in FIG. 11, in which the alignment mark AM has been moved to the detection area of the OA detection system. The OA-AF system measures a height of the wafer (or an alignment mark) (S112). The alignment mark AM is moved to a Z-position that is slightly defocused from a position having a value near the best focus of the OA detection system has already been calculated (S113). Again, the measurement by the OA-AF system takes in the image signal of the alignment mark AM and calculates the contrast and measurement position of the above alignment mark AM image. The contrast C(Zi) and the measurement value M(Zi) at the Z-position Zi in the optical-axis direction are calculated (S115). A calculation of the best focus position needs contrast values at plural Z-positions that cover the best focus. Therefore, the predetermined focus range is determined and it is determined whether C(Zi) and M(Zi) are calculated for the predetermined focus range (S116). If it does not end, the process returns to S113 to repeat S114 and S115 for different focus positions. This procedure reiterates and when the contrast C(Zi) and M(Zi) are calculated for the predetermined focus range, the best focus position Zp is calculated from a change of the contrast C(Zi) (S117). See FIG. 10. Next, the defocus characteristic is calculated at the best focus position Zp that has been calculated, using the mark position measurement values, i.e., minus-side defocus measurement value M(Zp−j), plus-side defocus measurement value M(Zp+j), and the measurement value M(Zp) at the best focus position.

The defocus characteristic can be calculated from three measurement values including the minus side, the defocus, and the plus side, and the gradient component T can be calculated using the approximate function from the measurement values at plural points. Conventionally, such a sequence image autofocus measurement has been proposed. The instant embodiment calculates the contrast value and the mark position. Since taking of the image is not repeated, the throughput is not reduced.

The sequence that has been described above is, and therefore not limited to, a mere illustration. Clearly, details of the wafer feed-in timing and image focus measurement order are not limited.

While the above embodiment proposes measurements under optimal condition of the gradient component T of the defocus characteristic relative to each process wafer, it is preferable for more precise correction to correct a difference between the gradient at the minus side and the gradient at the plus side, i.e., ΔT=T(−)−T(+), as shown in FIG. 6. Such a measurement difference results from coma in the above detection system. Each processed wafer can be optimized to minimize AT component, for example, by using a mechanism for eccentrically driving part of the objective and relay lenses relative to the optical axis in the detection optical system. The mechanism is not limited to the objective and relay lenses as long as it can control the coma in the optical path in the detection optical system.

While the above embodiment discusses one-way measurement, two-directional measurements are actually needed. However, it is understood that the above embodiment can be extended to the two-directional detections.

While the above embodiment discusses the OA detection system of an off-axis system that does not use a projection optical system, the present invention is applicable to the TTL system that detects through the projection optical system. While the instant detection system refers to a method of detecting an image of the alignment mark AM and calculating the position, the present invention is not limited to this method. For example, the present invention is applicable to not only a method for scanning a laser beam relative to the mark, and calculating the position based on the return light, but a method of using the coherence. The instant embodiment is directed to a method for previously measuring a measurement error (or defocus characteristic) that changes depending upon the Z-position of the alignment mark AM for each processed wafer, and for conducting an alignment measurement with the optimal defocus characteristic (which is zero).

A description will now be given of an embodiment of a device fabrication method using the exposure apparatus having the alignment detection system described in the above embodiment.

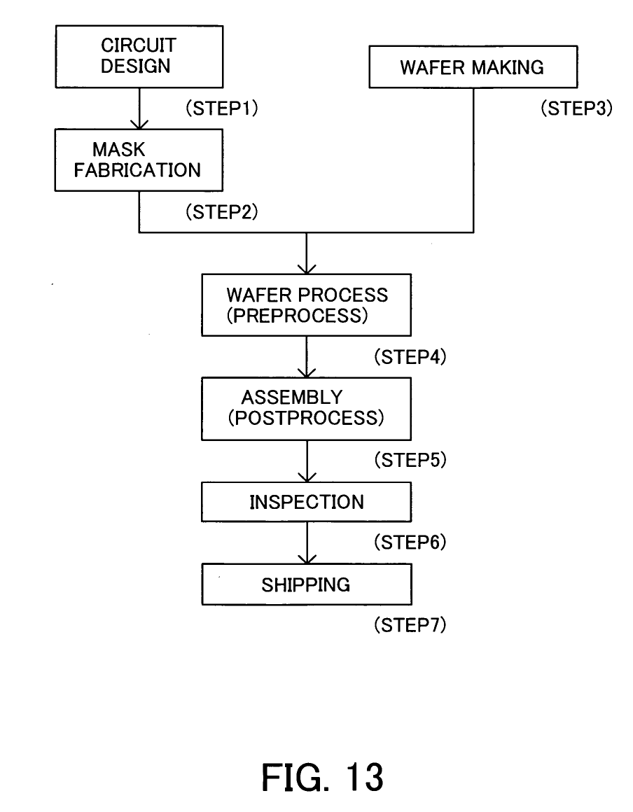

FIG. 13 is a manufacture flow of semiconductor devices (e.g., semiconductor chips such as IC and LSI, LCDs, CCDs). Step 1 (circuit design) designs a semiconductor device circuit. Step 2 (mask fabrication) forms a mask (reticle) having a designed circuit pattern. Step 3 (wafer preparation) manufactures a wafer using materials such as silicon. Step 4 (wafer process), which is also referred to as a pretreatment, forms actual circuitry on the wafer through lithography using the mask and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

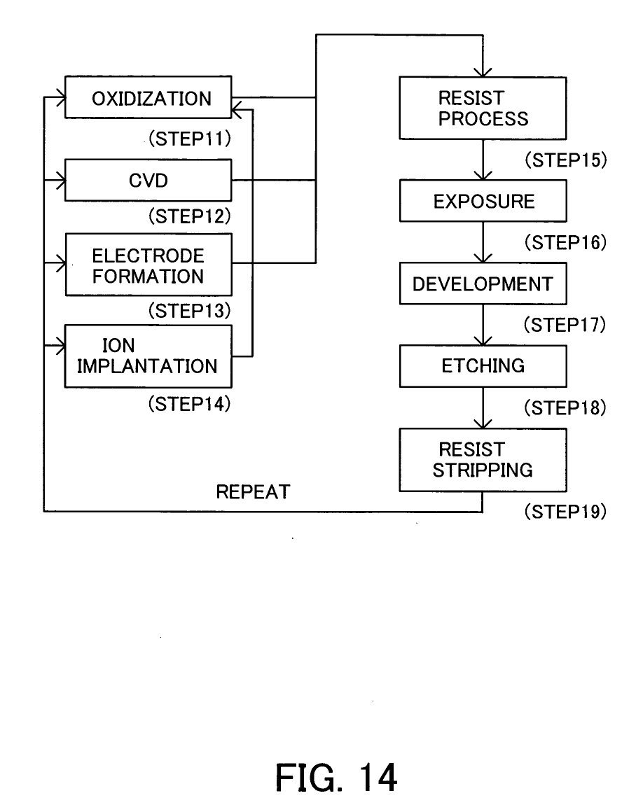

FIG. 14 is a detailed flow of the above wafer process. Step 11 (oxidation) oxidizes the wafer's surface. Step 12 (CVD) forms an insulating layer on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the projection exposure apparatus to expose a circuit pattern on the mask onto the wafer. Step 17 (development) develops the exposed wafer. Step 18 (etching) etches parts other than a developed resist image. Step 19 (resist stripping) removes disused resist after etching. These steps are repeated, and multi-layer circuit patterns are formed on the wafer.

Use of the fabrication method in this embodiment helps fabricate more highly integrated devices than conventional method.

1. An exposure apparatus for exposing a pattern on an original onto a substrate, said exposure apparatus comprising:
an illumination system for illuminating a mark on a substrate;
a detector for detecting a position of the mark by detecting light from the mark via an optical system;
a measurement unit for measuring a relationship between a focus state of said detector on the mark and a position detection result of the mark; and
a storage for storing substantially the same information as the relationship regarding the mark on the substrate to be exposed.

2. An exposure apparatus according to claim 1, further comprising a member for changing a state of the illumination light in the optical system based on the information.

3. An exposure apparatus according to claim 2, wherein the member decenters an opening position in an aperture stop in the optical system to the optical system.

4. An exposure apparatus according to claim 2, wherein the member is a parallel plate.

5. An exposure apparatus according to claim 1, wherein the storage stores an average value among plural marks on the substrate regarding the information.

6. A semiconductor device manufacturing method comprising the steps of:
exposing a pattern on an original onto a substrate using an exposure apparatus; and
developing the substrate that has been exposed, wherein the exposure apparatus comprising:
an illumination system for illuminating a mark on a substrate;
a detector for detecting a position of the mark by detecting light from the mark via an optical system;
a measurement unit for measuring a relationship between a focus state of said optical system on the mark and a position detection result of the mark; and
a storage for storing substantially the same information as the relationship regarding the mark on the substrate to be exposed.
